(19) United States
(12) Patent Application Publication
(10) Pub. No.: US 2006/0238161 A1
(43) Pub. Date: Oct. 26, 2006

(54) Tool usage monitoring apparatus

(76) Inventors: David G. Rusnell, Edmonton (CA); Timothy D. Rogers, Sherwood Park (CA); William John Woods, Edmonton (CA)

Correspondence Address: DAVIS & BUJOLD, P.L.L.C., 112 PLEASANT STREET, CONCORD, NH, 03301, US

(21) Appl. No.: 11/113,807

(22) Filed: Apr. 25, 2005

(51) Int. Cl. H02J 7/00

(52) U.S. Cl. 320/107

(57) ABSTRACT

A tool usage monitoring apparatus includes a housing in which is positioned a battery powered sensor and a processing unit. The processing unit is in communication with the sensor and controls power from the battery to the sensor, to switch the sensor from an active state and a dormant state. The processing unit includes a memory and a timer. The processing unit is programmed to switch the sensor from a dormant state to an active state at a preset periodic interval and record sensor data into the memory. The periodic time interval is not more than approximately every twenty minutes and not less than approximately every one minute, in order to maintain an accurate record of tool usage, while minimizing the size of the battery and the size of the memory required to record months of usage data.

### FIELD OF THE INVENTION

The present invention relates to an apparatus, which monitors tool usage and, in particular, usage of down hole tools.

### BACKGROUND OF THE INVENTION

In the oil and gas industry, many tools are rented. Pursuant to the terms of a standard rental arrangement, rental charges only accrue when the tool is actually being used for drilling an oil or gas well. For years, the company supplying the tools had no way of verifying when their tools were actually in use. For this reason, invoicing has traditionally been based upon the “honour” system; with the number of hours of actual usage being reported by the renting company to the supplying company. In view of some flagrant abuses that have taken place, there have been developed tool usage monitoring apparatus. Russell Subsurface Technologies, a division of National Oilwell, markets a device it calls a “Motor Hour Counter”. R&M Energy Systems, a division of Robbins & Meyers, Inc., have indicated their intentions to enter this market with a device it calls a “Moyno Rotor Sensor”. Russell Subsurface Technologies states in their literature that their device is suitable for use with sizes of 6½ inch diameter and upwards. R&M Energy Systems states in their literature their device will be suitable for use with motor sizes of 4¾ inch diameter and larger. There are currently no devices which are small enough to handle tool sizes smaller than 4¾ inch diameter.

SUMMARY OF THE INVENTION

According to the present invention there is provided a tool usage monitoring apparatus, which includes a housing having walls defining an interior cavity with an access opening into the interior cavity. A closure is provided for closing the access opening. A battery is disposed within the interior cavity of the housing. At least one sensor is provided which is adapted to sense a selected monitoring parameter. The sensor is disposed within the interior cavity of the housing and powered by the battery. A processing unit is disposed within the interior cavity of the housing and powered by the battery. The processing unit is in communication with the sensor and controls power from the battery to the sensor, to switch the sensor from an active state and a dormant state. The processing unit includes a memory and a timer. The processing unit is programmed to switch the sensor from a dormant state to an active state at a preset periodic interval and record sensor data into the memory. The periodic time interval is not more than approximately every twenty minutes and not less than approximately every one minute, in order to maintain an accurate record of tool usage, while minimizing the size of the battery and the size of the memory required to record months of usage data.

A stumbling block in reducing the size of tool usage monitoring apparatus, has been the size of memory required to record all of the data and the size of battery required to power the systems for over six months of use. A tool usage monitoring apparatus constructed in accordance with the teachings of the present invention can be made much smaller, as it takes less memory and less battery power to record sensor readings that are taken at intervals of between one and twenty minutes. Sampling more frequently than approximately every one minute is viewed as representing unacceptable drain on the battery. Sampling less frequently than approximately every twenty minutes is viewed as undermining the ability to determine hourly usage, as you would have fewer than three samples per hour.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a tool usage monitoring apparatus constructed in accordance with the teachings of the present invention.

FIG. 2 is a block diagram of the tool usage monitoring apparatus illustrated in FIG. 1.

### DETAILED DESCRIPTION OF THE PREFERRED EMBODIMENT

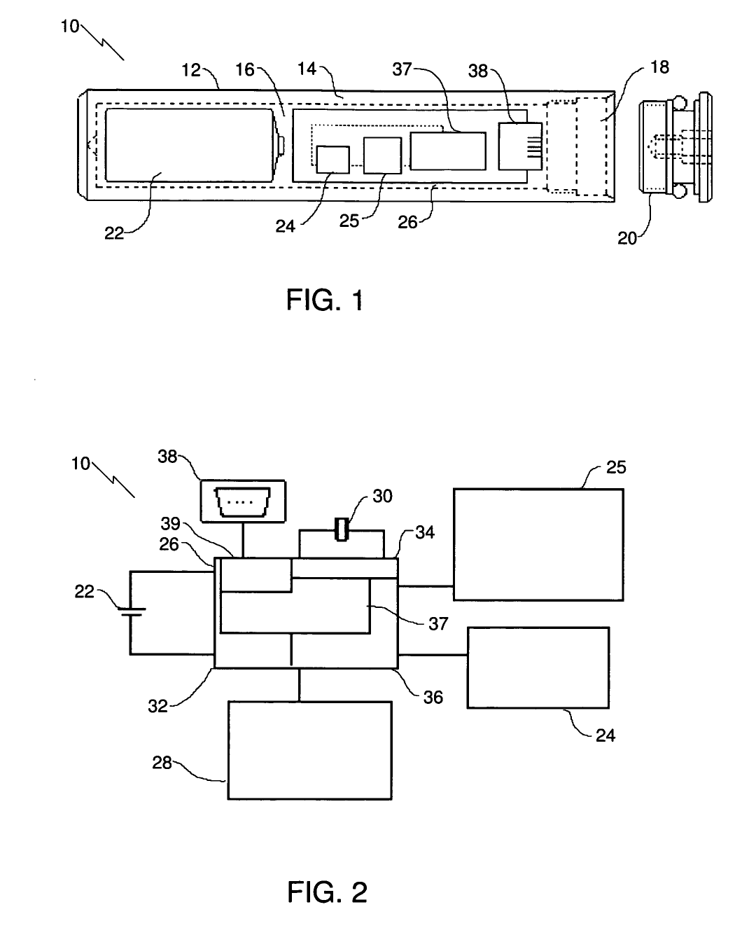

The preferred embodiment, a tool usage monitoring apparatus generally identified by reference numeral 10, will now be described with reference to FIGS. 1 and 2.

Structure and Relationship of Parts:

Referring now to FIG. 1, there is shown tool usage monitoring apparatus 10, including a housing 12 that has walls 14 defining an interior cavity 16 with an access opening 18 into interior cavity 16. Access opening is closed by a closure 20. A battery 22 is disposed within interior cavity 16 of housing 12 to power apparatus 10. There is at least one sensor, such as a temperature sensor 24 and an accelerometer 25 as depicted, adapted to sense a corresponding monitoring parameter disposed within interior cavity 16 of housing 12 and powered by battery 22. It will be understood that multiple sensors may be present, if desired.

Referring now to FIG. 2, a processing unit 26, including a memory 28 and a timing means 30, is disposed within interior cavity 16 of housing 12 and is also powered by battery 22. Processing unit 26 also includes a power management component 32, a time management component 34, a data acquisition component 36, and a download port 38 to download the acquired data to a computer. Processing unit 26 is in communication with sensors 24 and 25 and controls power from battery 22 to sensor 24, such that sensor 24 has an active state and a dormant state. Processing unit 26 is programmed to switch sensor 24 from a dormant state to an active state at a preset periodic interval and record sensor data in memory 28. It is preferred that the periodic time interval is not more than every twenty minutes and not less than every one minute in order to maintain an accurate record of tool usage, while minimizing the size of battery 22 and the size of memory 28 required to record months of usage data. The preferred sampling frequency is every five to ten minutes.

Operation:

The operation and use of tool usage monitoring apparatus 10 will now be discussed with reference to FIGS. 1 and 2. Referring now to FIG. 1, apparatus 10 is supplied with the components as described above, and installed on a tool (not shown). Processing unit 26 controls is connected to battery 22, and controls the power to sensor 24. At regular intervals, preferably between 5 and 10 minutes, time management component 34 causes sensor 24 to sample a desired monitoring parameter, which can later be used to determine whether the tool was in use or not during that period. The parameter is then stored in memory 28 for future use in determining the usage of the tool. When the rented tool is returned, tool usage monitoring apparatus 10 is connected to a computer and the recorded sensor data is downloaded for analysis. Since the sensor data was recorded periodically, the total time the tool was in use can be derived by multiplying the number of sensor samples that indicated that the tool was in use by the sample time interval.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A tool usage monitoring apparatus, comprising:
a housing having walls defining an interior cavity with an access opening into the interior cavity;
a closure for closing the access opening;
a battery disposed within the interior cavity of the housing;
at least one sensor adapted to sense a selected monitoring parameter, disposed within the interior cavity of the housing and powered by the battery;
a processing unit disposed within the interior cavity of the housing and powered by the battery, the processing unit being in communication with the sensor and controlling power from the battery to the sensor, such that the sensor has an active state and a dormant state, the processing unit, including:
a memory; and
timing means;
the processing unit being programmed to switch the sensor from a dormant state to an active state at a preset periodic interval and record sensor data into the memory, the periodic time interval being not more than every twenty minutes and not less than every one minute in order to maintain an accurate record of tool usage, while minimizing the size of the battery and the size of the memory required to record months of usage data.

2. The tool usage monitoring apparatus as defined in claim 1, wherein the sensor is a temperature sensor.

3. The tool usage monitoring apparatus as defined in claim 1, wherein the sensor is an accelerometer.

4. The tool usage monitoring apparatus as defined in claim 1, wherein the periodic time interval is between five and ten minutes.
